(19) United States
(12) Patent Application Publication
(10) Pub. No.: US 2013/0204548 A1
(43) Pub. Date: Aug. 8, 2013

(54) TIRE PRESSURE SENSOR DEVICE AND ITS SETTING METHOD

(71) Applicants: San-Chuan YU, Changhua County (TW); Ting-Chun Chien, Changhua County (TW); Chi-Hung Chen, Changhua County (TW)

(72) Inventors: San-Chuan YU, Changhua County (TW); Ting-Chun Chien, Changhua County (TW); Chi-Hung Chen, Changhua County (TW)

(21) Appl. No.: 13/367,826

(22) Filed: Feb. 7, 2012

(51) Int. Cl. B60C 23/02

(52) U.S. Cl. 702/50

(57) ABSTRACT

A tire pressure sensor device setting method includes the steps of: providing a setting tool and selecting a control program to be downloaded, providing a tire pressure sensor device, driving an infrared transmitter of the setting tool to encode the selected control program into an infrared signal and to transmit the infrared signal to an infrared receiver of the tire pressure sensor device, enabling the tire pressure sensor device to transmit a feedback signal to the setting tool wirelessly to stop the setting tool from transmitting the infrared signal, and enabling a processor and memory unit of the tire pressure sensor to decode the received infrared signal into a decoded control program and to store the decoded control program in a memory thereof.

### BACKGROUND OF THE INVENTION

1. Field of the Invention

The present invention relates to tire pressure monitoring technology and more particularly, to a tire pressure sensor device and its setting method.

2. Description of the Related Art

Setting a commercial tire pressure sensor device can be down in two ways. The first way is to electrically connect the tire pressure sensor device to a setting device by a cable, enabling the control program to be loaded from the setting device onto the tire pressure sensor device. This first way requires complicated plugging and unplugging operations. Further, as the tire pressure sensor device must provide a connection port for the connection of the cable, it has a large size. The second way is a wireless setting method, which uses a low frequency signal, for example, 125 kHz, to link the setting device and the tire pressure sensor device and to transmit the control program from the setting device to the tire pressure sensor device. This wireless setting method eliminates complicated plugging and unplugging operations, and enables the size of the tire pressure sensor to be minimized. However, as the wireless signal is penetrative, the program in the tire pressure sensor device may be edited accidentally. For example, when the user is downloading a control program to the tire pressure sensor device at the front left wheel of the car wirelessly, the tire pressure sensor at the front right wheel of the car may simultaneously receive the wireless signal and load the signal onto its memory, causing an error.

### SUMMARY OF THE INVENTION

The present invention has been accomplished under the circumstances in view. It is the main object of the present invention to provide a tire pressure sensor device setting method, which employs infrared transmission technology to achieve setting, eliminating wire connection and avoiding accidental false editing.

To achieve this and other objects of the present invention, a tire pressure sensor device setting method includes the steps of (a) providing a setting tool comprising an infrared transmitter and selecting a control program to be downloaded onto a tire pressure sensor device; (b) providing a tire pressure sensor device comprising an infrared receiver; (c) driving the infrared transmitter of the setting tool to encode the selected control program into an infrared signal and to transmit the infrared signal to the infrared receiver of the tire pressure sensor device; (d) enabling the tire pressure sensor device to transmit a feedback signal to the setting tool wirelessly to stop the setting tool from transmitting the infrared signal; and (e) enabling the processor and memory unit of the tire pressure sensor to decode the received infrared signal into a decoded control program and to store the decoded control program in a memory thereof, thereby finishing the setting.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a setting tool operation flow chart according to the present invention.

FIG. 2 is a tire pressure sensor device operation flow chart according to the present invention.

FIG. 3 is a function block diagram of a setting tool according to the present invention.

FIG. 4 is a function block diagram of a tire pressure sensor device according to the present invention.

### DETAILED DESCRIPTION OF THE INVENTION

Referring to FIG. 4, a tire pressure sensor device in accordance with the present invention is shown comprising a processor and memory unit, a pressure sensor electrically coupled to the processor and memory unit for sensing the internal pressure of a tire of a vehicle, a temperature sensor electrically coupled to the processor and memory unit for sensing the internal temperature of the tire of the vehicle, an acceleration sensor electrically coupled to the processor and memory unit for sensing the acceleration value of the tire, a LF (low frequency) transmission interface and a RF (radio frequency) transmission interface respectively electrically coupled to the processor and memory unit for transmitting the sensed data to an on-vehicle receiver by a low frequency or radio frequency, a battery pack electrically coupled to the processor and memory unit for providing the programmable tire pressure sensor device with the necessary working power supply, and an infrared receiver electrically coupled to the processor and memory unit for receiving an external infrared signal.

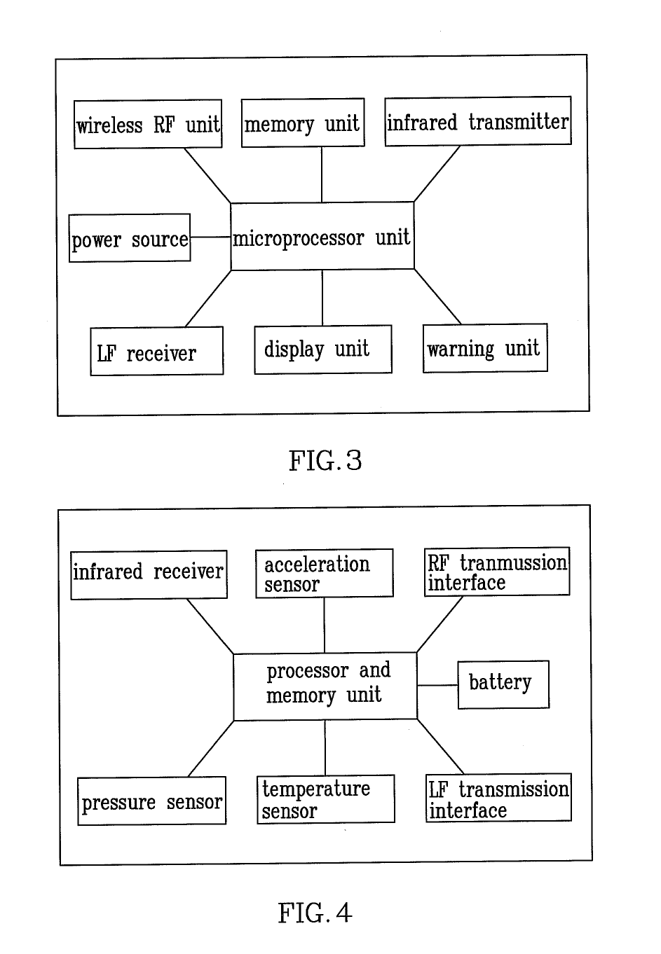

For setting the tire pressure sensor device, a setting tool shall be used. As shown in FIG. 3, the setting tool comprises a microprocessor unit, a memory unit, a display unit electrically coupled to the microprocessor unit for displaying operation data, a power source for providing the setting tool with the necessary working electricity, a warning unit electrically coupled to the microprocessor unit for giving of a warning signal, an infrared transmitter electrically coupled to the microprocessor unit, and a wireless RF (radio frequency) unit and a LF (low frequency) receiver unit respectively electrically coupled to the microprocessor unit.

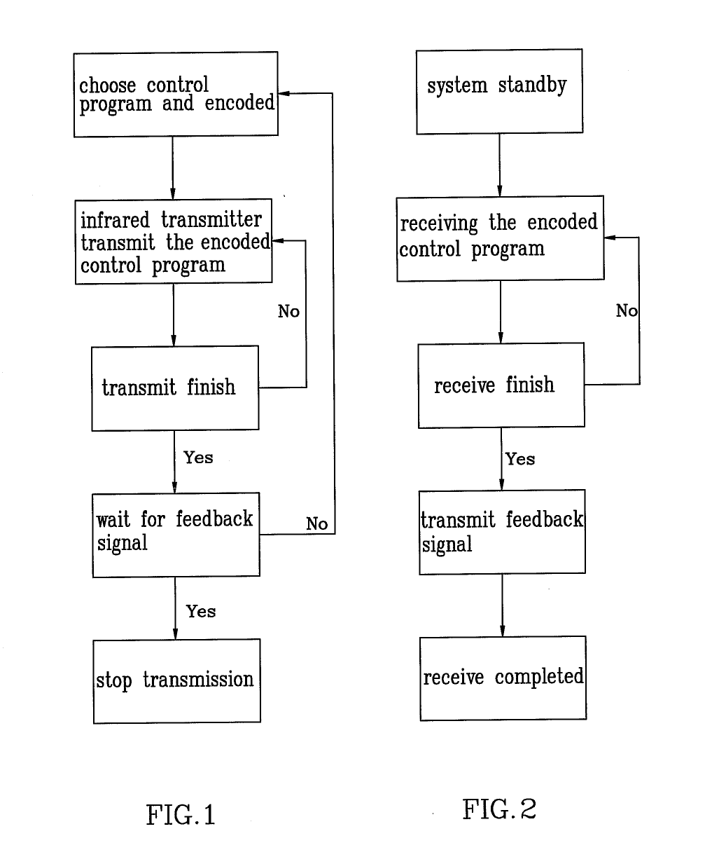

Referring to FIGS. 1 and 2, the setting method of the present invention is to encode the control program to be downloaded onto the infrared tire sensor device. The control program may vary with different brands or models of cars. Thereafter, drive the infrared transmitter of the setting tool to transmit the encoded control program to the infrared receiver of the tire pressure sensor device. After receipt of the encoded control program, the tire pressure sensor device gives off a feedback signal to the setting tool wirelessly. Upon receive of the feedback signal by the LF (low frequency) receiver unit of the setting tool, the setting tool immediately stops the transmission. The setting tool will keep transmitting the control program through its infrared transmitter before receiving the feedback signal.

The infrared signal received by the infrared receiver of the tire pressure sensor device will be transmitted to the processor and memory unit, and then decoded by the processor and memory unit. The decoded control program will then be stored in the memory of the processor and memory unit, completing the setting of the downloaded control program. After setting, the tire pressure sensor device can transmit the sensed temperature, pressure and acceleration data through its LF (low frequency) transmission interface and RF (radio frequency) transmission interface to the on-vehicle head unit wirelessly.

As infrared transmission is a highly directional wireless transmission, setting the tire pressure sensor device by means of infrared transmission eliminates complicated plugging/unplugging operations and avoids accidental editing in a wrong location due to non-directional wireless signal penetration. Infrared signal transmission is a known technology for transmitting signal. However, this technology has not been used for downloading programs. Using infrared transmission technology in the present invention eliminates the problems of conventional tire pressure sensor devices, improving product installation efficiency.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A tire pressure sensor device setting method, comprising the steps of:
(a) providing a setting tool comprising an infrared transmitter and selecting a control program to be downloaded onto a tire pressure sensor device;
(b) providing a tire pressure sensor device comprising an infrared receiver;
(c) driving the infrared transmitter of said setting tool to encode the selected control program into an infrared signal and to transmit the infrared signal to the infrared receiver of said tire pressure sensor device;
(d) enabling said tire pressure sensor device to transmit a feedback signal to said setting tool wirelessly to stop said setting tool from transmitting the infrared signal; and
(e) enabling said processor and memory unit of said tire pressure sensor to decode the received infrared signal into a decoded control program and to store the decoded control program in a memory thereof, thereby finishing the setting.

2. The tire pressure sensor device setting method as claimed in claim 1, wherein said setting tool keeps transmitting said infrared signal infrared receiver of said tire pressure sensor device before receipt of a feedback signal from said tire pressure sensor device.

3. The tire pressure sensor device setting method as claimed in claim 1, wherein said tire pressure sensor device comprises a processor and memory unit, a pressure sensor electrically coupled to said processor and memory unit for sensing the internal pressure of a tire of a vehicle, a temperature sensor electrically coupled to said processor and memory unit for sensing the internal temperature of said tire of said vehicle, an acceleration sensor electrically coupled to said processor and memory unit for sensing the acceleration value of said tire of said vehicle, a LF (low frequency) transmission interface and a RF (radio frequency) transmission interface respectively electrically coupled to said processor and memory unit for transmitting the sensed temperature, pressure and acceleration data to an on-vehicle receiver by a low frequency or radio frequency, a battery pack electrically coupled to said processor and memory unit for providing the tire pressure sensor device with the necessary working power supply, and an infrared receiver electrically coupled to said processor and memory unit for receiving an external infrared signal.

4. The tire pressure sensor device setting method as claimed in claim 1, wherein said setting tool further comprises a microprocessor unit electrically coupled with said infrared transmitter of said setting tool, and a display unit electrically coupled to said microprocessor unit for displaying operation data.

5. The tire pressure sensor device setting method as claimed in claim 4, wherein said setting tool further comprises a warning unit electrically coupled to said microprocessor unit for giving of a warning signal.

6. A tire pressure sensor device comprises: a processor and memory unit, a pressure sensor electrically coupled to said processor and memory unit for sensing the internal pressure of a tire of a vehicle, a temperature sensor electrically coupled to said processor and memory unit for sensing the internal temperature of said tire of said vehicle, an acceleration sensor electrically coupled to said processor and memory unit for sensing the acceleration value of said tire of said vehicle, a LF (low frequency) transmission interface and a RF (radio frequency) transmission interface respectively electrically coupled to said processor and memory unit for transmitting the sensed temperature, pressure and acceleration data to an on-vehicle receiver by a low frequency or radio frequency, a battery pack electrically coupled to said processor and memory unit for providing the tire pressure sensor device with the necessary working power supply, and an infrared receiver electrically coupled to said processor and memory unit for receiving an external infrared signal.
